(19) United States
(12) Patent Application Publication
(10) Pub. No.: US 2025/0271785 A1
(43) Pub. Date: Aug. 28, 2025

(54) IMAGE FORMING APPARATUS

(71) Applicant: CANON KABUSHIKI KAISHA, Tokyo (JP)

(72) Inventors: TORU IMAIZUMI, Kanagawa (JP); TOMOO AKIZUKI, Kanagawa (JP); YUSUKE SHIMIZU, Kanagawa (JP)

(21) Appl. No.: 19/051,095

(22) Filed: Feb. 11, 2025

(30) Foreign Application Priority Data
Feb. 22, 2024 (JP) 2024-026009

(51) Int. Cl. G03G 15/04

(52) U.S. Cl. CPC G03G 15/04072; G03G 15/04027; G03G 2215/0404; G03G 2215/0439

(57) ABSTRACT

An image forming apparatus includes a photosensitive member, an exposing unit scanning the photosensitive member with a laser, a generating unit generating a clock signal, a first correcting unit correcting a frequency of the clock signal for each position in a main scanning direction, a developing unit, a driving unit, a second correcting unit correcting an image date by a correction coefficient depending on the position in the main scanning direction, and a modulating unit modulating the image date corrected by the second correcting unit into the driving signal. The correction coefficient increases as it goes toward an end from a center in the main scanning direction and includes an inflection point where an inclination, which is an increase amount of the correction coefficient to a unit increase amount of the position, is changed. The inflection point is positioned near the end in the main scanning direction.

### FIELD OF THE INVENTION AND RELATED ART

The present invention relates to an image forming apparatus, and in particular to an image forming apparatus of electrophotographic type which performs writing using a laser beam.

The image forming apparatus of electrophotographic type is provided with an optical scanning unit for exposing a photosensitive member. The optical scanning unit emits a laser light based on image data, and by reflecting the laser light with a rotating polygon mirror and permitting the laser light to pass through a scanning lens, the photosensitive member is exposed. By rotating the rotating polygon mirror, scanning, in which a spot of the laser light formed on a surface of the photosensitive member is moved, is performed and a latent image is formed on the photosensitive member.

The scanning lens is a lens having a so-called fθ characteristic. The fθ characteristic is an optical characteristic which causes the laser light to form an image on the surface of the photosensitive member so that the spot of the laser light on the surface of the photosensitive member is moved at a constant speed when the rotating polygon mirror is rotated at a constant angular speed. By using the scanning lens having the fθ characteristic in this manner, appropriate exposure can be performed. The scanning lens with such fθ characteristic is larger in size, which leads to an increase in size of the image forming apparatus. For this reason, for a purpose of downsizing the image forming apparatus, image forming apparatuses which do not use the scanning lens itself or which use a scanning lens which does not have the fθ characteristic have been considered. For example, in the U.S. Patent No. U.S. Pat. No. 4,532,552, even in a case in which the spot of the laser light on the surface of the photosensitive member does not move at a constant speed on the surface of the photosensitive member, to make dots formed on the surface of the photosensitive member have a constant width, a method in which an electrical correction is performed so as to change an image clock frequency during one scan, is disclosed. In addition, for example, in the U.S. patent application Laid-Open No. US2015/0365554, according to a scanning speed at which a laser light moves over the photosensitive member, a pixel width correction, which corrects a length in a main scanning direction of each pixel of image data, and a density correction, which corrects so as to make image density lighter as the scanning speed is slower, are disclosed.

However, in a case in which, without using the scanning lens having the fθ characteristic, an image clock frequency is changed in the main scanning direction and correction is performed by a pixel width correcting means (unit), in a region with high clock frequency in the main scanning direction, a corrected width may become smaller. In particular, in a higher speed apparatus, it is required to make an overall clock frequency itself higher, therefore the corrected width becomes even smaller. In a case in which a time when the laser is turned off becomes a few nanoseconds or shorter due to the correction, the corrected width may become below a limit of responsiveness of a laser. In this case, a light amount of the laser actually irradiated on the surface of the photosensitive member may not be as originally intended, and image defect such as uneven density may occur.

### SUMMARY OF THE INVENTION

The present invention provides a means or a unit which suppresses an occurrence of image defect such as uneven density even in an image forming apparatus, in which an image clock frequency is changed in a scanning direction, without using a scanning lens having an fθ characteristic.

In other words, the present invention has the following configuration:

(1) An image forming apparatus for performing image formation by transferring a toner image onto a recording material, the image forming apparatus comprising: a photosensitive member on which a latent image is formed; an exposing unit configured to scan the photosensitive member with a laser light of which a scanning speed is changed depending on a position in a main scanning direction, and to form the latent image on the photosensitive member; a generating unit configured to generate a clock signal for controlling a turn on timing of the laser light; a first correcting unit configured to correct a frequency of the clock signal for each position in the main scanning direction; a developing unit configured to develop the latent image on the photosensitive member with toner and to form the toner image; a driving unit configured to drive the laser light based on a driving signal; a second correcting unit configured to correct an image data, which is input, by a correction coefficient depending on the position in the main scanning direction; and a modulating unit configured to modulate the image data corrected by the second correcting unit into the driving signal, wherein the correction coefficient includes an inflection point where an inclination, which is an increase amount of the correction coefficient to a unit increase amount of the position in the main scanning direction, is changed, and wherein the inflection point is positioned near the end portion in the main scanning direction.

According to the present invention, it becomes possible to suppress an occurrence of image defect such as uneven density even in an image forming apparatus, in which an image clock frequency in a scanning direction is changed, without using a scanning lens having an fθ characteristic.

Further features of the present invention will become apparent from the following description of exemplary embodiments with reference to the attached drawings.

### BRIEF DESCRIPTION OF THE DRAWINGS

FIG. 1 is a view of an outline configuration of an image forming apparatus in an Embodiment.

FIG. 2, part (a) and part (b), includes cross-sectional views of an optical scanning device in the Embodiment.

FIG. 3 is a relationship view of an image height and a partial magnification in the Embodiment.

FIG. 4 is an electrical block diagram of an exposure control configuration in the Embodiment.

FIG. 5 is a timing relationship view of various types of synchronizing signals and an image signal in the Embodiment.

FIG. 6 is a function block diagram of an image processing flow in the Embodiment.

FIG. 7 is a view illustrating an example of a table of pulse signals in the Embodiment.

FIG. 8 is a view showing a profile of a correction table for a pulse width in the Embodiment.

FIG. 9, part (a) and part (b), includes a view showing a profile of a correction table for a pulse width in a Comparative Example for comparison with the Embodiment, and a view showing light amount distribution in a main scanning direction in the Comparative Example.

FIG. 10 is a view showing a light amount distribution in a main scanning direction in the Embodiment.

FIG. 11 is a view illustrating a Modified Example of the profile of the correction table for the pulse width in the Embodiment.

### DESCRIPTION OF THE EMBODIMENTS

### Embodiment

### <Image Forming Apparatus>

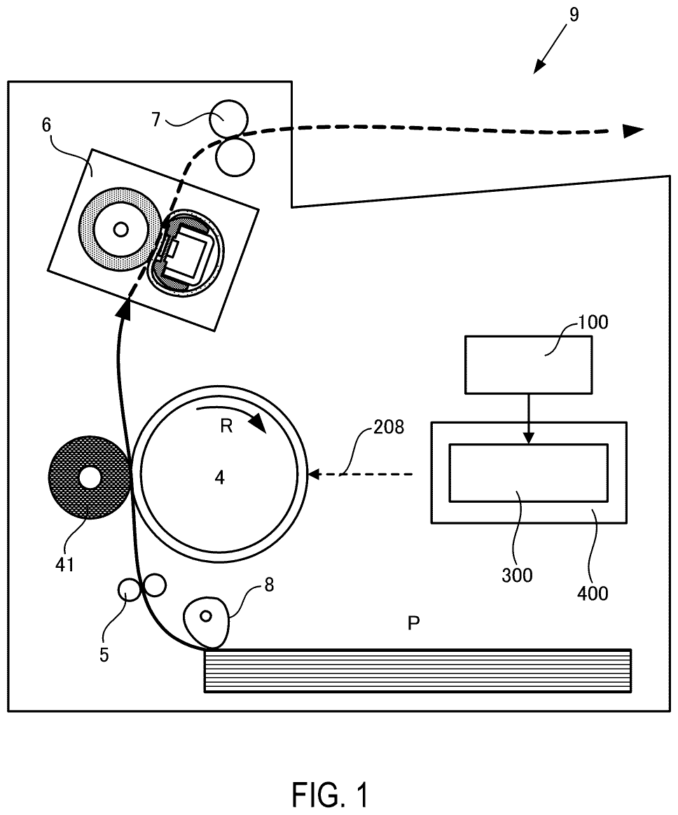

FIG. 1 is a view of an overall configuration of a laser printer 9 (hereinafter, simply referred to as a printer 9) as an image forming apparatus in an Embodiment. The printer 9 is a printer which is capable of outputting up to a letter size (215.9 mm×279.4 mm) sheet with respect to a widthwise direction. The printer has a resolution of 600 dpi and a throughput of 24 ppm.

A photosensitive drum (photosensitive member) 4 is uniformly charged to a predetermined polarity and potential by an unshown charging roller (charging means, charging unit) in a process of being rotated in an R direction. A laser driving portion (driving means, driving unit) 300 in an optical scanning device (exposure means, exposure unit) 400 emits a laser light (scanning light) 208 based on an image signal (driving signal) output from an image signal generating portion 100. The optical scanning device 400 forms a latent image on a surface of the photosensitive drum 4 by scanning the laser light 208 on the photosensitive drum 4. And the printer 9 causes toner to adhere to the latent image with an unshown developing means (unit), and forms a toner image corresponding to the latent image. A sheet P as a recording medium (recording material) is fed from a sheet feeding unit 8 and conveyed to a transfer nip portion, which is formed by the photosensitive drum 4 and a transfer roller 41, by a conveyance roller 5. The toner image on the photosensitive drum 4 is transferred to the sheet P by using the transfer roller 41. The unfixed toner image which is transferred to the sheet P is thermally fixed to the sheet P in a fixing device 6 and discharged outside the apparatus through a discharging roller 7.

The printer 9 in the present Embodiment uses the photosensitive drum 4, which is charged to negative polarity, and the toner of negative polarity, and of the photosensitive drum 4, a charging potential (Vd) is −500V, a developing potential (Vdc) is −300V, and an exposure potential (VI) upon the laser being turned on over an entire region in one pixel is −100V. A spot diameter of the laser is about 60 μm at an on-axis image height and about 80 μm at a most off-axis image height on the photosensitive drum 4. About the on-axis image height and the most off-axis image height will be described below. A size of the pixel is 42.3 μm×42.3 μm.

### <Optical Scanning Device>

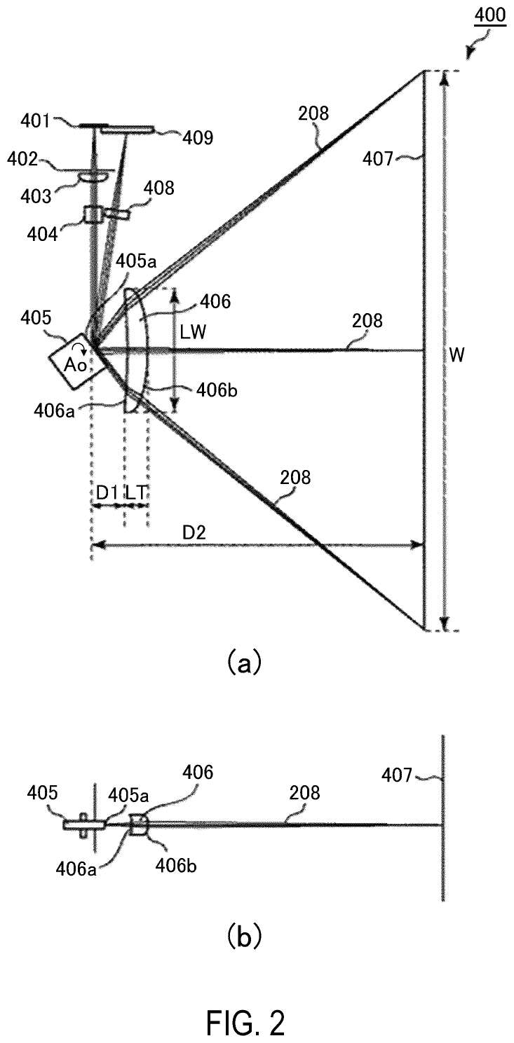

FIG. 2 includes cross-sectional views of the optical scanning device 400 in the present Embodiment, and part (a) of FIG. 2 illustrates a main scanning cross section and part (b) of FIG. 2 illustrates a sub scanning cross section. A moving direction of a laser spot on the photosensitive drum 4 due to rotation of a rotating polygon mirror, which will be described below, is referred to as a main scanning direction, and a direction perpendicular to the main scanning direction is referred to as a sub scanning direction.

In the present Embodiment, the laser light 208 which is emitted from a light source 401 is shaped into an elliptical shape by an aperture diaphragm 402 and is incident on a coupling lens 403. A light flux which has passed through the coupling lens 403 is converted to an approximately collimated light and is incident on an anamorphic lens 404. The anamorphic lens 404 has a positive refractive power in the main scanning cross section and converts the incident light flux into a converged light in the main scanning cross section. In addition, the anamorphic lens 404 condenses the light flux in a vicinity of a deflecting surface (reflecting surface) 405a of a rotating polygon mirror (deflector) 405 in the sub scanning cross section, and forms a long line image in the main scanning direction.

And the light flux which has passed through the anamorphic lens 404 is reflected at the deflecting surface 405a of the rotating polygon mirror 405. Here, the rotating polygon mirror 405 is described by exemplifying the deflector, which is constituted by four reflecting surfaces, however, the number of the reflecting surfaces is not limited thereto. The laser light 208 reflected at the deflecting surface 405a passes through an imaging lens 406 and forms an image on the surface of the photosensitive drum 4, and forms a predetermined image of a spot shape (hereinafter, denoted as a “spot”). Incidentally, 406a is a surface on an incident side of the imaging lens 406 and 406b is a surface on an emitting side of the imaging lens 406. By rotating the rotating polygon mirror 405 at a constant angular speed in a direction of an arrow Ao (clockwise direction in FIG. 2) by a driving portion (not shown), the spot is moved in the main scanning direction on a scanned surface 407 of the photosensitive drum 4, and an electrostatic latent image is formed on the scanned surface 407.

A beam detector (hereinafter, denoted as BD) 409 and a BD lens 408 are an optical system for synchronization which determines a timing for writing the electrostatic latent image on the scanned surface 407. The laser light 208 which has passed through the BD lens 408 is incident on and detected by the BD 409, which includes a photodiode. A BD signal is output each time the deflecting surface 405a of the rotating polygon mirror 405 is turned to the next one. Based on timings in which the laser light 208 is detected by the BD 409, control of timings for writing is performed. The light source 401 in the present Embodiment is provided with a single light emitting portion, however, as the light source 401, it may be a light source which includes a plurality of light emitting portions, which can be independently controlled to emit light.

The light source 401 is a semiconductor laser chip. The imaging lens 406 does not have a so-called fθ characteristic. By using the imaging lens 406 which does not have the fθ characteristic, downsizing of the optical scanning device 400 is realized. That is, it become possible to position the imaging lens 406 closer to the rotating polygon mirror 405 (at a position in which a distance D1 is smaller). In addition, in the imaging lens 406 which does not have the fθ characteristic, a length in the main scanning direction (width LW) and a length in an optical axis direction (thickness LT) can be made smaller than an imaging lens which has the fθ characteristic.

Since the imaging lens 406 in the present Embodiment does not have the fθ characteristics, when the rotating polygon mirror 405 is rotated at a constant angular speed, the spot does not move at a constant speed on the scanned surface 407. In addition, the spot diameter on the scanned surface 407 is not constant. In particular, since the shorter an optical passage length (D2) from the rotating polygon mirror 405 to the photosensitive drum 4, the larger an angle of view, a difference of scanning speeds and a difference of the spot diameters at the on-axis image height and at the most off-axis image height get larger. In the present Embodiment, in such the optical configuration, keeping of an image quality is aimed.

### <Partial Magnification Correction>

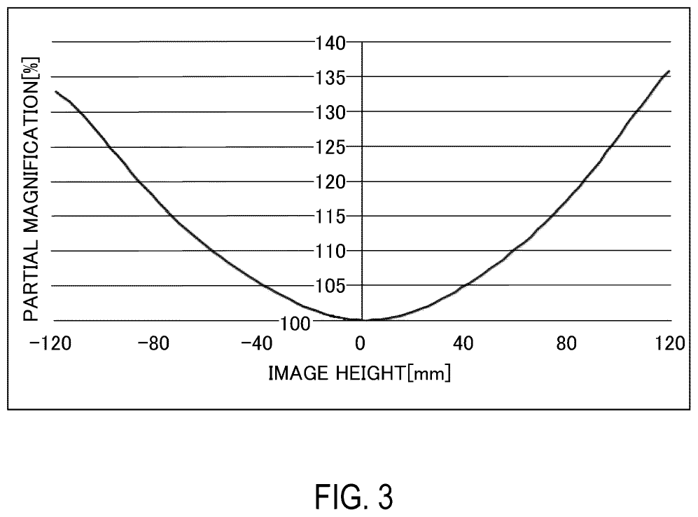

In FIG. 3, relationship between the image height and a partial magnification as a characteristic of the optical scanning device 400 in the present Embodiment is shown. In FIG. 3, a horizontal axis represents the image height [mm] and a vertical axis represents the partial magnification [%]. Incidentally, the image height becomes 0 in a case in which the spot is on the optical axis of the imaging lens 406, and hereinafter it is referred to as the “on-axis image height”. In addition, the image height other than the on-axis image height is hereinafter referred to as the “off-axis image height”. Furthermore, a maximum value of an absolute value of the image height is referred to as the “most off-axis image height”.

As illustrated in part (a) of FIG. 2, a length (width) in the main scanning direction of the scanned surface 407 of the photosensitive drum 4 is defined as W. Then, a position of the most off-axis image height in the scanned surface 407 is W/2 from a center thereof. In FIG. 3, for example, the partial magnification of the image height is 130% means that the scanning speed at the image height is about 1.3 times of the scanning speed at the image height in which the partial magnification is 100%.

In the example in FIG. 3, the scanning speed at the on-axis image height is the lowest, and the larger the absolute value of the image height, the faster the scanning speed becomes. Therefore, when a pixel width in the main scanning direction is determined at a constant time interval determined by a cycle of a clock signal, which is used for a timing to turn on the laser light, a pixel density becomes different between the on-axis image height and the off-axis image height. For this reason, in the present Embodiment, a partial magnification correction is performed. Specifically, a frequency of the clock signal (hereinafter referred to as a clock frequency) is adjusted according to the image height so that the pixel width is substantially constant regardless of the image height.

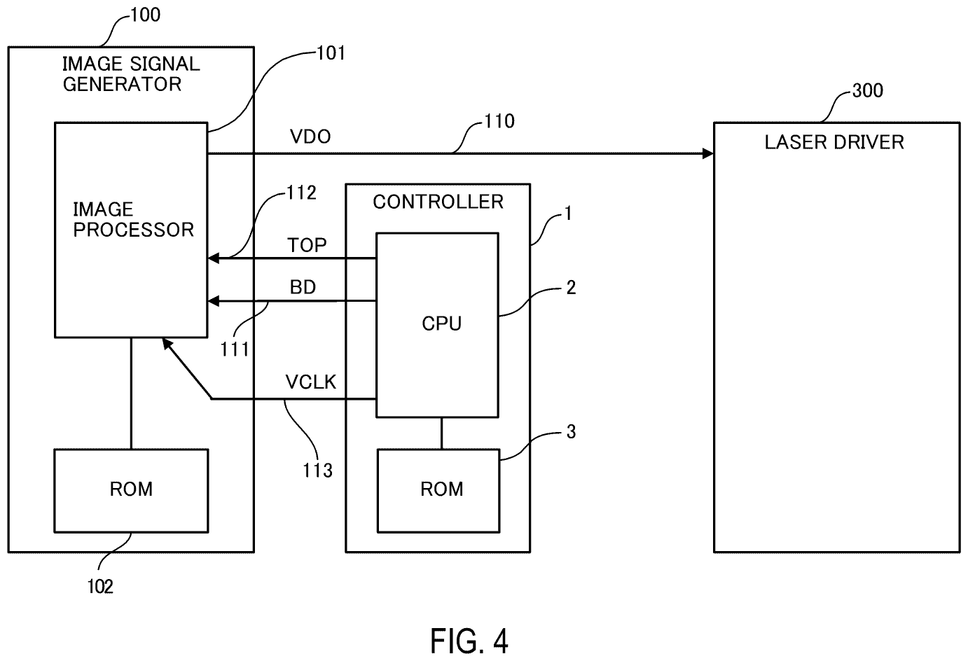

In a ROM 3 in FIG. 4, a clock frequency ratio relating to the optical scanning device 400 is stored, and based on this information, a CPU 2 sends a video clock signal VCLK 113 to an image processing portion 101 to control the clock frequency. In other words, the clock frequency ratio of a VDO signal 110, which is transmitted from the image processing portion 101, is set to 135% at the most off-axis image height when the on-axis image height is set to 100%. The CPU 2 functions as a generating means (unit), which generates the clock signal, and a first correcting means (unit), which corrects a frequency of the video clock signal (clock signal) for each position in the main scanning direction based on the clock frequency ratio illustrated in FIG. 3. At this time, a time, in which the spot of the laser light 208 is moved over the scanned surface 407 by the width of one pixel (e.g., 42.3 μ), is 0.74 times of the on-axis image height at the most off-axis image height. As such, by controlling an exposure time of the laser light 208 at a pixel position corresponding to one pixel, it becomes possible to correct the width of the pixel and form the latent image corresponding to each pixel having substantially the same width and the same size with respect to the main scanning direction.

However, in a case in which brightness of the light source 401 is constant, a total exposure amount per unit length near the most off-axis image height is less than the total exposure amount per unit length near the on-axis image height. Therefore, in the present Embodiment, in order to obtain a good image quality, in conjunction with the correction of the partial magnification described above, correction of a pulse width to correct the total exposure amount per unit length is performed. The details of the correction of the pulse width will be described below.

### <Exposure Control Configuration>

FIG. 4 is a block diagram illustrating an exposure control configuration in the printer 9. The image signal generating portion 100 includes the image processing portion 101 and a ROM 102. The image signal generating portion 100 receives a printing data from an unshown host computer and generates the corresponding VDO signal 110. In addition, the image signal generating portion 100 has a function as a density correcting means (unit) which corrects an image density. A control portion 1 performs an overall control of the image signal generating portion 100 and the printer 9. On the laser driving portion 300, an unshown laser driver IC is mounted. The laser driver IC controls ON (turn on)/OFF (turn off) of the light source 401 based on the VDO signal 110. The laser driver IC performs an automatic adjustment of the brightness by performing a feedback control with a circuit inside the laser driver IC so that the brightness detected by a photodetector (not shown), which is provided to the light source 401 as a light amount monitor, becomes a desired brightness. So-called, an APC (Auto Power Control) is performed.

Upon preparation for an output of an image signal for an image formation being ready, the image signal generating portion 100 instructs a start printing to the control portion 1. The control portion 1 is provided with the CPU 2, and upon preparation for the printing being ready, the CPU 2 sends a TOP signal 112, which is a sub scanning synchronizing signal, and a BD signal 111, which is a main scanning synchronizing signal, to the image signal generating portion 100. The image signal generating portion 100 outputs the VDO signal 110, which is the image signal (driving signal), to the laser driving portion 300 at a predetermined timing after receiving the synchronizing signals.

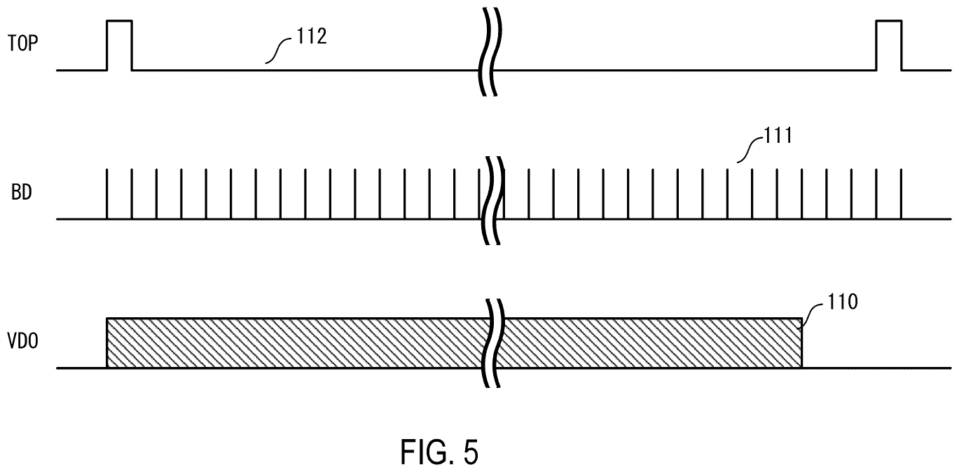

FIG. 5 is a view illustrating relationship of timings between the various types of the synchronizing signals and the image signal upon performing an image forming operation, which corresponds to one page of the recording medium, along a position in the sub scanning direction. In the figure, time elapses from left to right. “HIGH”s of the TOP signal 112 represent that leading ends of the sheet P have reached a predetermined position. Upon receiving the “HIGH” of the TOP signal 112, in synchronization with the BD signal 111, the image signal generating portion 100 sends the VDO signal 110. Based on the VDO signal 110, the light source 401 is turned on, and the latent image is formed on the photosensitive drum 4.

Incidentally, in FIG. 5, for simplification of the figure, the VDO signal 110 is illustrated as being output continuously over a plurality of the BD signals 111. However, in practice, the VDO signal 110 is output during a predetermined period within a period between one BD signal 111 is output and the next BD signal 111 is output. The automatic adjustment of the brightness of the light source 401 is performed while the light source 401 is turned on for detecting the BD signal 111 at an outside of a print region for each main scanning line.

### <Image Processing Flow>

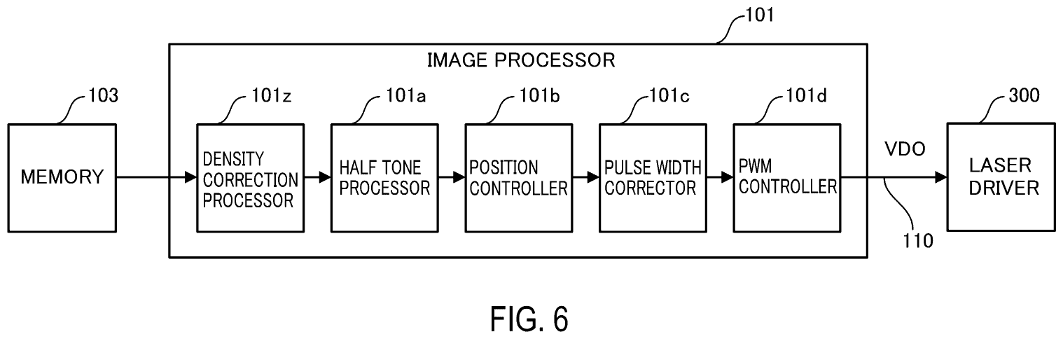

Next, an image processing flow of the printer 9 in the present Embodiment will be described. FIG. 6 is a function block diagram describing the image processing flow during the printing. The image processing portion 101 is provided with a density correction processing portion 101z, a halftone processing portion 101a, a position control portion 101b, a pulse width correcting portion 101c and a PWM control portion 101d, which are shown in FIG. 6, and performs the image processing flow described below.

The printer 9 in the present Embodiment performs a gray scale conversion based on a dither method, and performs an image processing to obtain a continuous halftone image. A print data which is input from the host computer (not shown) is once stored in a memory 103. And the print data is read out from the memory 103, and after a correcting process is performed to a halftone print data based on a correction table in the density correction processing portion 101z, the print data is sent to the halftone processing portion 101a as a halftone processing means (unit). The halftone processing portion 101a performs a multi-value dither processing to the print data having a bit depth of 8-bit (256 gray scales) and converts the print data to an image data having the bit depth of 8-bit. By using a position control matrix corresponding to a dither matrix, which is used for the multi-value dither processing by the halftone processing portion 101a, the position control portion 101b adds 2-bit position control data, which represents a growing direction of a dot, to the image data output by the halftone processing portion 101a. The pulse width correcting portion 101c and the PWM control portion 101d will be described below in detail. Incidentally, the pulse width correcting portion 101c performs a pulse width correction according to a position in the main scanning direction of the 8-bit image data, to which the position control data is added, and the PWM control portion 101d performs a PWM control, converts the image data into the VDO signal 110, which is a pulse signal, and outputs the VOD signal 110 to the laser driving portion 300.

Through such image processing using the dither method, the image processing portion 101 converts the print data into the VDO signal 110 for exposure, to which the halftone processing for the printer to express the gray scale properly is performed.

### <Pulse Width Modulation Control Portion (PWM Control Portion)>

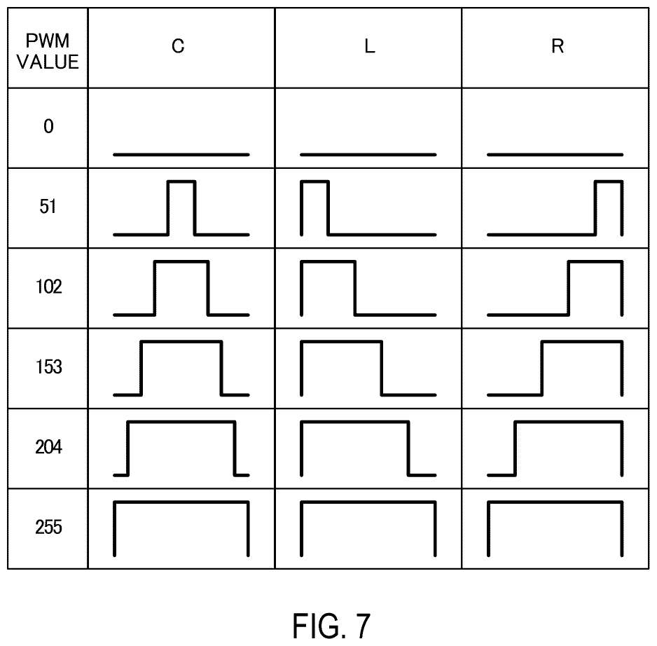

The PWM (Pulse Width Modulation) process by the PWM control portion 101d, which is a modulating means (unit), will be described. In FIG. 7, an example of a table showing relationship between data assigned to each pixel by the position control portion 101b and the pulse signals generated by the PWM process is illustrated. In this table, information related to a width of the pulse signal (PWM value) and a position of the pulse signal is included. The PWM control portion 101d performs the PWM processing with dividing the image date input thereto into 8-bit data (PWM value: 0 through 255) and 2-bit data (position control data: C, L and R), which are assigned to each pixel, and generates the pulse signal.

The PWM values have integer values from 0 to 255. A pulse position is information corresponding to a delay amount of a leading position of the pulse signal from a reference position of an image clock signal (for example, starting point of one pixel), which defines the pixel width to which the pulse signal is synchronized. In the table shown in FIG. 7, it is configured that, as a level of the PWM value increases from 0 (no light emission), the width of the pulse signal gets wider at the pulse position and in the growing direction, which correspond to the position control data. In a case in which the position control data is C, as the PWM value gets larger, the width of the pulse signal grows from the reference position, which is a center of a pixel, to left and right directions in approximately the same manner. In a case in which the position control data is L, as the PWM value gets larger, the width of the pulse signal grows from the reference position, which is a left end of a pixel, to the right direction. In a case in which the position control data is R, as the PWM value gets larger, the width of the pulse signal grows from the reference position, which is a right end of a pixel, to the left direction. When the PWM value is 255, the light is emitted over the entire pixel width of one pixel. By performing such process, the PWM control portion 101d converts the 8-bit image data into a video signal (VDO signal 110), which is the pulse signal.

### <Pulse Width Correcting Portion>

The pulse width correcting portion 101c as a second correcting means (unit), which characterizes the present Embodiment, will be described. In the present Embodiment, as described above, since the scanning speed in the main scanning direction is not constant and the control of the clock frequency is performed, in a case in which a light amount emitted by the laser is set to be constant, a constant light amount cannot be obtained in the main scanning direction on the photosensitive drum 4. Therefore, in the pulse width correcting portion 101c, correction of the pulse width, which is processed by the PWM control portion 101d, is performed.

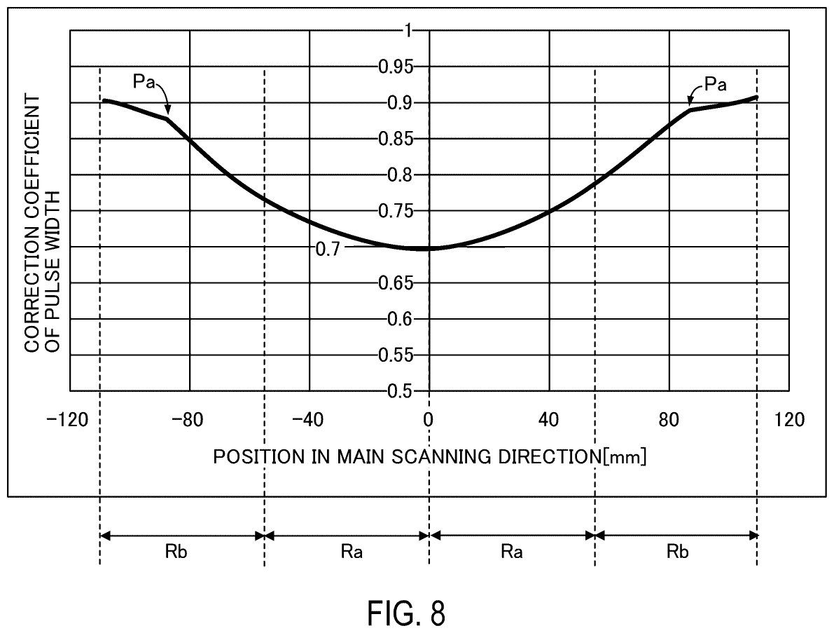

In FIG. 8, a graph of a correction table for the pulse width corresponding to each main scanning position by the pulse width correcting portion 101c is shown. The correction table for the pulse width is a table which associates the positions in the main scanning direction with correction coefficients for the pulse width. In the graph of the correction table for the pulse width in FIG. 8, a horizontal axis represents the positions in the main scanning direction [mm] and a vertical axis represents the correction coefficients for the pulse width. As a characteristic of the present Embodiment, a shape of the correction table for the pulse width is configured to have a recessed shape at a central portion relative to end portions with respect to the positions in the main scanning direction, and further configured to be a shape which has inflection points Pa near the both end portions. In the present Embodiment, the inflection points Pa are provided at positions of ±87 mm in the main scanning direction.

An inclination of the correction table for the pulse width in the present Embodiment is 0.00326 for the inclination at the positions of 81 through 86 in the main scanning direction, which are closer to a center side than the inflection point Pa, and is 0.000362 for the inclination at the positions of 88 through 93 in the main scanning direction, which are closer to the end portion side than the inflection point Pa. In this manner, the inclination of the correction table for the pulse width largely changes before and after the inflection point Pa. Specifically, the inclination in a region closer to the center side than the inflection point Pa is larger than the inclination in a region closer to the end portion side than the inflection point Pa.

To the image data for each pixel, which are input from the position control portion 101b, the pulse width correcting portion 101c applies the correction table in FIG. 8 corresponding to the positions in the main scanning direction of each pixel. Specifically, an image data after correction is defined as a value which is obtained by multiplying the value of the correction table shown in FIG. 8 (correction coefficient) corresponding to the positions in the main scanning direction to the image data before correction, and rounding to the nearest whole number.

For example, in a case of the image data of 255 at a position 0 in the main scanning direction (central portion in a longitudinal direction (on-axis image height)), the correction coefficient of 0.698 is multiplied thereto, i.e., 255×0.698=177.99, and the result is rounded to the nearest whole number, i.e., 178. In addition, in a case of the image data of 128 at a position 0 in the main scanning direction, the correction coefficient of 0.698 is multiplied thereto, i.e., 128×0.698=89.344, and the result is rounded to the nearest whole number, i.e., 89. In a case of the image data of 255 at a position 100 in the main scanning direction, the correction coefficient of 0.897 is multiplied thereto, i.e., 255×0.897=228.735, and the result is rounded to the nearest whole number, i.e., 229. In a case of the image data of 128 at a position 100 in the main scanning direction, the correction coefficient of 0.897 is multiplied thereto, i.e., 128×0.897=114.816, and the result is rounded to the nearest whole number, i.e., 115.

As described above, the pulse width correcting portion 101c performs the correction corresponding to the positions in the main scanning direction of each pixel to the image data before correction (0 through 255) and obtains the image data after correction (0 through 255). In the present Embodiment, in practice, since a maximum value of the correction table for the pulse width is 0.905, the image data after correction takes values of 0 through 231.

After the above correction is performed by the pulse width correcting portion 101c, the 8-bit image data is converted into the video signal (VDO signal 110), which is the pulse signal, by the PWM control portion 101d as described in FIG. 7, and is sent to the laser driving portion 300. By the pulse width correcting portion 101c performing the correction described above, the pulse width of a PWM signal, which is sent as the VDO signal 110 from the PWM control portion 101d, is subtracted. Incidentally, the correction table is stored in the memory 103.

### <Effect of the Invention>

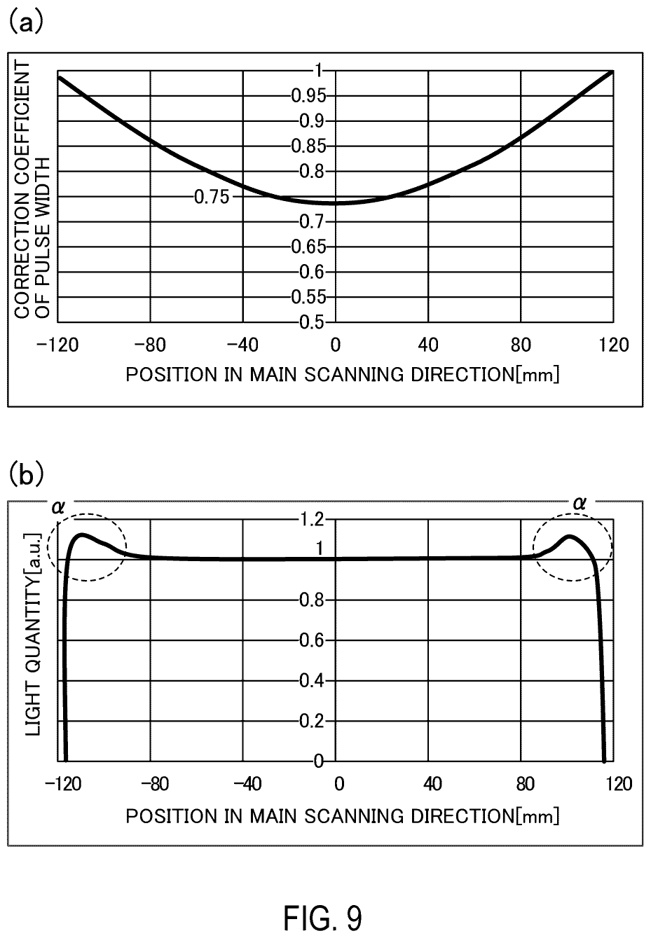

As a Comparative Example for describing an effect of the present invention, a case in which a correction table having a monotonous recessed shape at a center thereof is applied will be described together. Part (a) of FIG. 9 is an example of the correction table of the Comparative Example having the monotonous recessed shape at the center thereof, such as a one which is proportional to the clock frequency. A horizontal axis and a vertical axis of the graph in part (a) of FIG. 9 are the same as those in FIG. 8. With the ideal light source 401 showing response characteristic which exactly follows the VDO signal 110, by performing the correction in this manner, light amount distribution on the photosensitive drum 4 should become uniform in the main scanning direction. However, depending on the response characteristic of a laser element, there is a case in which such is not the case. As described above, near the end portions in the main scanning direction, the clock frequency is high. In addition, an amount of the subtraction near the end portion in the main scanning direction is slight, and an OFF time of the laser, which is obtained by multiplying a subtracting ratio of the pulse width and a time for one pixel, which is an inverse of the clock frequency, becomes a small amount of time. Through investigation by the inventors of the present invention, it is found that when the OFF time of the laser is 5 nsec or less, in particular is 3.5 nsec or less, response of the light source 401 is not in time, and there is a case in which the light emission by the light source 401 is not actually turned off. This response characteristic includes a characteristic of an electrical circuit on a laser substrate in addition to the characteristic of the laser element alone.

In a case in which the correction table for the pulse width as the Comparative Example in part (a) of FIG. 9 is used, the distribution of the light amount in the main scanning direction on the photosensitive drum 4 has a shape projecting above partially near the end portions in the main scanning direction (broken line circles a), as shown in part (b) of FIG. 9. In part (b) of FIG. 9, a horizontal axis represents the position in the main scanning direction [mm] and a vertical axis represents the light amount [a.u.]. Incidentally, with respect to the light amount, the light amount at 0 mm (center) in the main scanning direction is expressed as 1.

The light amount on the surface of the photosensitive drum 4 can be checked by placing a light receiving element at a position corresponding to the photosensitive drum 4 surface and measuring the irradiated laser light 208. When an image is printed under the condition as in the Comparative Example, since an amount of applied toner is increased at the portions at which the light amount gets large (broken line circles a), the image density becomes dense near end portions of the image in the main scanning direction.

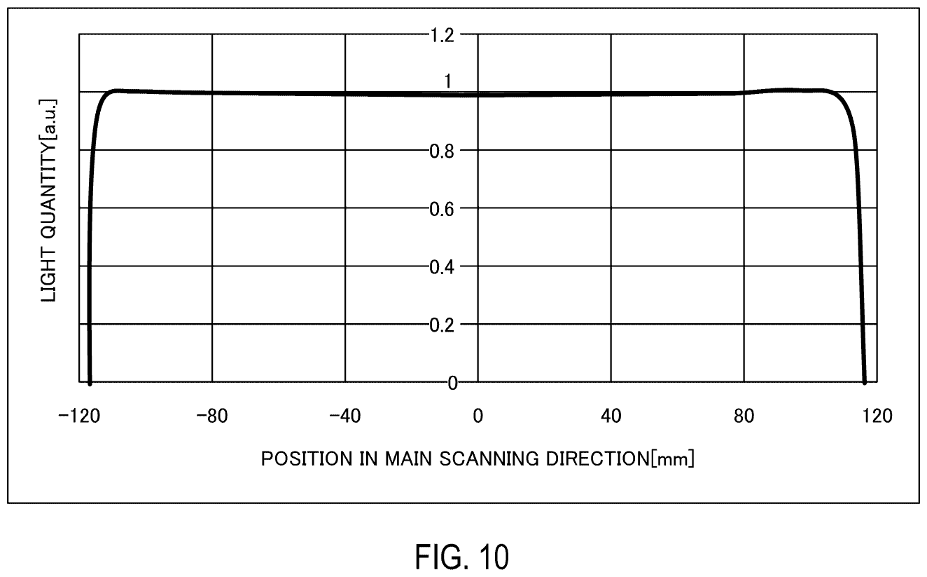

In a case in which the correction table for the pulse width in the present Embodiment is used, the distribution of the light amount in the main scanning direction on the surface of the photosensitive drum 4 is shown in FIG. 10. A horizontal axis and a vertical axis in FIG. 10 are the same as those in part (b) of FIG. 9. In the present Embodiment, as shown in FIG. 10, the light amount distribution, which is substantially flat in the main scanning direction, can be obtained. At the end portions in the main scanning direction, the subtraction of the pulse width with the correction table in FIG. 8 is configured to be larger than the Comparative Example. As such, by configuring the subtraction larger at a time region in which the laser has some difficulty in response, it becomes possible to obtain the flat light amount distribution. In the present Embodiment, in the region around the positions of ±87 mm in the main scanning direction, such as the OFF time of the laser is around 3.5 nsec, the shape of the correction table for the pulse width has the inflection points Pa.

In the present Embodiment, even in a case of data which corresponds to a solid black such as the image data before the correction is 255, since the correction is performed by the pulse width correcting portion 101c, it is configured that substantially there is no pixel in which the laser is entirely turned on. That is, in the correction table in FIG. 8, a correcting value is less than 1 over the entire longitudinal direction. By performing the pulse width correction as described above, it becomes possible to obtain the light amount distribution which is substantially flat in the main scanning direction, and to obtain an image with even dense.

The correction coefficients shown in FIG. 8 in the present Embodiment change so as to increase as it goes toward the end portion from the central portion in the main scanning direction. That is, as viewed over an entire region in the main scanning direction, the correction coefficient changes so as to be the recessed shape at the position of the center in the main scanning direction. In addition, the correction coefficients are changing so as to include the inflection points Pa near the end portions in the main scanning direction. The inflection point Pa is included, in the main scanning direction, in a region closer the end portion when a region from the center to the end portion is divided into two (two equal regions).

That is, as shown in FIG. 8, the inflection points Pa are included in regions Rb, which are closer to the end portions, of two regions Ra and Rb, which are equally divided into the two regions. For example, in a case in which a maximum size (maximum sheet passing width) of the sheet P, to which the printer 9 can perform the image formation, is a letter size, the region Ra is from 0 mm to ±54 mm and the region Rb is from ±55 mm to ±108 mm. In this case, the inflection point Pa of the correction coefficient is included in the region from ±55 mm to ±108 mm, which is the region Rb. Incidentally, in other printers which have a different maximum sheet passing width than that of the printer 9, a range in the main scanning direction of the regions Ra and Rb and positions of the inflection points P also becomes different, however, the inflection point Pa is included in the region Rb regardless of the maximum sheet passing width.

Incidentally, in the configuration described above, with respect to the resolution in the main scanning direction and the sub scanning direction, 600 dpi is exemplified and described, however, it is not limited thereto but other resolutions may be employed. In addition, the relationship between the position in the main scanning direction and the partial magnification shown in the present Embodiment (FIG. 3) is an example, and information used for the various types of the control may be defined corresponding to a change in this relationship. Incidentally, in the present Embodiment, an example in which the halftone is expressed based on the multi-value dither processing is described, however, it is not limited thereto but other halftone expressing methods may also be used.

### <About a Case in Which the Light Amount is Insufficient at the End Portion>

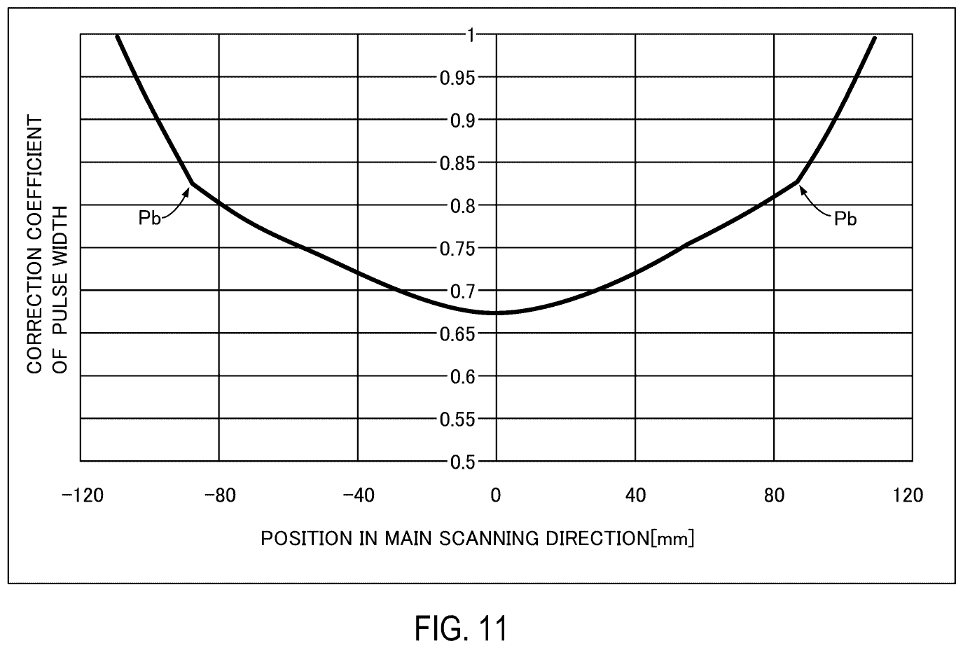

In the present Embodiment, the example in which the inclination of the correction table for the pulse width becomes smaller on the end portion side relative to the center side in the main scanning direction at the inflection point Pa as a boarder, is described. On the other hand, in a case of an image of which a light emitting width is short such as a one dot image, in a region in which the clock frequency at the end portion in the main scanning direction is large, due to delay of response in turning on of the light source 401, conversely, the light amount may be insufficient. In such a case, as shown in FIG. 11, a correction table for the pulse width, in which the inclination becomes larger on the end portion side at the inflection point Pb as a boarder, may be employed. FIG. 11 is a graph showing the correction table for a case in which, when control to turn on the light source 401 in a short time at the end portion side is performed, due to the delay of the response of the light source 401, the laser cannot be turned on actually and the light amount thereof becomes insufficient.

In the graph of FIG. 11, a horizontal axis represents the positions in the main scanning direction [mm] and a vertical axis represents the correction coefficients for the pulse width. In the graph of FIG. 11, the inclinations of the graph in regions closer to the end portion sides than the inflection points Pb are larger than the inclinations of the graph in a region closer to a central portion. Incidentally, the other configurations of the correction table are the same as those described in FIG. 8.

The control portion 1 can also identify an image through a pattern matching, etc., for example, for the image data, apply the correction table for the pulse width as in FIG. 11 only to the one dot image, and apply the correction table for the pulse width as in FIG. 8 to the other images.

As described above, the correction tables as shown in FIG. 8 and FIG. 11 in the present Embodiment are the tables which associate the positions in the main scanning direction with the correction coefficients for the pulse width. The correction coefficient is set so as to be increased as it goes toward the end portion from the central portion in the main scanning direction. In the present Embodiment, the inflection point at which the inclination, which is an increase amount of the correction coefficient to a unit increase amount of the position in the main scanning direction, is changed is included. That is, between the central portion and the end portion in the main scanning direction, the inclination in the region closer to the center side is different from the inclination in the region closer to the end portion side. When the region from the central portion to the end portion in the main scanning direction is divided into two (two equal portions), the inflection point is included in the region on the end portion side of the two regions. Upon performing the control to turn off the light source 401 in a short time, due to the delay of the response of the light source 401, the light may not actually be turned off and the light amount there may become large. For the correction of such image data, the correction coefficient, which is set so that the inclination on the end portion side than the inflection point is smaller than the inclination on the center side than the inflection point, is used. Upon performing the control to turn on the light source 401 in a short time, due to the delay of the response of the light source 401, the light may not actually be turned on and the light amount there may become insufficient. For the correction of such image data, the correction coefficient, which is set so that the inclination on the end portion side than the inflection point is larger than the inclination on the center side than the inflection point, is used.

In addition, the correction table may be a correction table in which a plurality of the correction coefficients for the positions in a plurality of the main scanning direction are set, or a correction table in which the correction coefficients are given as a function of the positions in the main scanning direction.

As described above, according to the present Embodiment, even in the image forming apparatus which changes the image clock frequency in the scanning direction without using the scanning lens which has the fθ characteristic, it becomes possible to suppress the occurrence of the image defect such as uneven density.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-026009 filed on Feb. 22, 2024, which is hereby incorporated by reference herein in its entirety.

What is claimed is:

1. An image forming apparatus for performing image formation by transferring a toner image onto a recording material, the image forming apparatus comprising:
a photosensitive member on which a latent image is formed;
an exposing unit configured to scan the photosensitive member with a laser light of which a scanning speed is changed depending on a position in a main scanning direction, and to form the latent image on the photosensitive member;
a generating unit configured to generate a clock signal for controlling a turn on timing of the laser light;
a first correcting unit configured to correct a frequency of the clock signal for each position in the main scanning direction;
a developing unit configured to develop the latent image on the photosensitive member with toner and to form the toner image;
a driving unit configured to drive the laser light based on a driving signal;
a second correcting unit configured to correct an image data, which is input, by a correction coefficient depending on the position in the main scanning direction; and
a modulating unit configured to modulate the image data corrected by the second correcting unit into the driving signal,
wherein the correction coefficient includes an inflection point where an inclination, which is an increase amount of the correction coefficient to a unit increase amount of the position in the main scanning direction, is changed, and
wherein the inflection point is positioned near the end portion in the main scanning direction.

2. The image forming apparatus according to claim 1, wherein when a region between a central portion and the end portion in the main scanning direction is equally divided into two regions, the inflection point is included in a region of an end portion side of the two regions.

3. The image forming apparatus according to claim 1, wherein the first correcting unit corrects the clock signal in the position of an end portion side from a position corresponding to the inflection point in the main scanning direction so as to cause the laser light to turn on or turn off for a time equal to 5 nsec or less.

4. The image forming apparatus according to claim 1, wherein an inclination in a region closer to an end portion side than the inflection point is smaller than an inclination in a region closer to a center side than the inflection point.

5. The image forming apparatus according to claim 1, wherein an inclination in a region closer to an end portion side than the inflection point is larger than an inclination in a region closer to a center side than the inflection point.

6. The image forming apparatus according to claim 1, wherein the correction coefficient is less than 1 in a whole region in positions of the main scanning direction, and
wherein the second correcting unit corrects the image data, which is input, by multiplying the correction coefficient and makes a corrected image data.

7. The image forming apparatus according to claim 1, further comprising a halftone processing unit configured to perform a halftone processing by a dither matrix before the second correcting unit corrects.

8. The image forming apparatus according to claim 1, wherein the correction coefficient increases as it goes toward an end portion from a central portion in the main scanning direction.
